(19) United States
(12) Patent Application Publication
(10) Pub. No.: US 2002/0031126 A1
(43) Pub. Date: Mar. 14, 2002

(54) Bit synchronizer and internetworking system and method

(76) Inventors: James Conrad Crichton, Derwood, MD (US); Mohammed Gomaa Abutaleb, Potomac, MD (US); Jeffrey Richard Jacobson, Bethesda, MD (US); David Joseph Megel, Gaithersburg, MD (US); Danny Edward McConnell, McLean, VA (US); Max Alan Gold, Charles Town, WV (US)

Correspondence Address: GEORGE E. DARBY, P.O. BOX 893010, MILILANI, HI, 96789-3010, US

(21) Appl. No.: 09/953,317

(22) Filed: Sep. 12, 2001

Related U.S. Application Data
(60) Provisional application No. 60/232,094, filed on Sep. 12, 2000.

(51) Int. Cl. H04L 12/56

(52) U.S. Cl. 370/394; 370/395.6; 370/506

(57) ABSTRACT

A system for bit synchronous communications over packet networks with adverse delay conditions is provided by sequencing in association with a local terminal fixed-sized payloads from an input bitstream and reassembling in association with a remote terminal the received payloads in sequence. Delayed, dropped, duplicated, and mis-sequenced packets are repaired through the use of a smoothing buffer associated with the remote terminal.

### RELATED APPLICATION

This application claims the benefit of the provisional patent application, serial No. 60/232,094, filed on Sept. 12, 2000, the U.S. Patent and Trademark Office for an invention entitled “Bit Synchronizer and Internetworking System and Method”.

### BACKGROUND OF THE INVENTION

1. Field of the Invention

The requirement for secure voice, data, and facsimile communications and supporting network interfaces is well established in government agencies and private businesses. Where transmission technologies are standardized and especially if satellite transmission is used, e.g., voice calling with Inmarsat satellite terminals and regional transponder beams, it is relatively straightforward for unknown parties with a modicum of skills to intercept a transmission and eavesdrop on information content that is not protected (encrypted). Such protection can be accomplished by each end-user's use of a secure communications device (herein, a “secure device”), such as a secure telephone unit (“STU”). The most common STUs are STU-IJI and STU-IIB models, which typically have a single analog network interface and two internal signal paths: clear, and secure. Initial call setup is performed using the clear (unencrypted) signal path. Viewed from the perspective of the local terminal, the outbound secure signal path comprises an analog to digital conversion of the signal from the handset microphone or other transmitter, voice encoding to reduce the required bit rate, encryption of the resultant bitstream by a cryptographic module, processing of the bitstream by a voice-band modem, and output from the modem to an analog network interface. Voice-band modems typically have an output pass-band of 300 Hz 3,000 KHz to match the passband of standard voice networks. At the local terminal, the inbound secure signal path comprises an input from an analog network interface to the voice-band modem, processing by the modem to produce an output bitstream, decryption of the bitstream by a cryptographic module, reconstruction of the digitized voice signal by a voice compression decoder, digital to analog conversion of the bitstream, and provision of the analog signal to an analog end-user interface (handset receiver, etc.).

During dialing by the calling party (herein, the “local” party, who uses a “local” secure device or terminal) and answer by the called party (herein, the “remote” party, who uses a “remote” secure device or terminal), the clear signal path is used. The local and remote parties can converse using the unprotected, clear signal path. To protect the call, one party initiates secure mode, normally by pressing a button on the secure device (if the local and remote devices support data mode, in a computer to computer call, software in one computer would initiate secure mode). An initiation of secure mode first causes the secure signal path subsystem in each secure device to commence modem training. Modem training normally involves an exchange of local and remote modem tones, followed by an exchange of local and remote capabilities messages, and includes the negotiation of a datarate. During the training period, the modems adjust internal parameters to optimize performance given the loss, delay, noise, and other characteristics of the current connection. Modem training is followed by synchronization of the cryptographic modules in STUs or similar secure devices. To obtain synchronization of cryptographic modules, secure devices normally first use a block cipher, such as Data Encryption Standard, to exchange a “rule”, i.e., a seed key and optionally a pseudo-random number generating algorithm and a starting position in the pseudorandom number sequence generated by use of the seed key and algorithm. The rule is used later by a stream cipher to encrypt the local to remote path. A similar process is performed for the remote to local path. The seed key, algorithm, and sequence starting position can be different in each half of a duplex voice or secure duplex data call. Once the seed key, algorithm, and sequence starting position are exchanged between the cryptographic modules in the local and remote secure devices for each half-duplex path, the secure devices switch to a stream cipher that can encrypt a continuous bitstream, such as encoded voice.

Some secure devices use an algorithm stored in the secure device, or always start at the same point in the pseudo-random sequence, and therefore do not exchange algorithms or starting positions, respectively, during secure call setup. Many stream ciphers rely on an adder register which performs “exclusive adds” of each sequential bit of an encoded voice or data bitstream with the corresponding bit in sequence from the local pseudo-random number generator. In the local secure device, the encryptor (the encryption process within the transmitting cryptographic module of the local secure device) and the pseudo-random number generator are locked to the same clock. In the remote secure device, the decryptor (the decryption process within the receiving cryptographic module of the remote secure device) and the pseudo-random number generator are locked to the same clock. In the encryptor, the first bit of clear data or encoded voice in the local to remote path is “exclusively added” to the bit of the pseudo-random number sequence at the specified starting position. Such addition produces an encrypted bitstream that can be transmitted securely over a terrestrial telecommunications network (“TTN”) or over a satellite network. Stream ciphers other than those using adder registers can be used. In short, secure and bit synchronous devices require “bit count integrity” to operate normally. “Bit count integrity” over a network means that the data bits emerging from the network at a remote terminal are the same bits in the same order as the data bits entering the network from the local terminal originating the bitstream, and except for individual bit errors, there is no loss or duplication.

To decrypt the encrypted bitstream at a remote terminal, the “exclusive add” or similar process is reversed, which requires that the correct bit in the sequence of pseudo-random bits generated by the pseudo-random number generator at the remote terminal be matched with the correct bit in the encrypted data or voice bitstream at the remote terminal site. By using the correct local to remote path seed key, algorithm, sequence starting position, and clock timing, the cryptographic module of the remote secure device can perform such matching and thereby decrypt the encrypted bitstream. In a secure voice call, when correctly decrypted output is fed to the voice compression decoder of a remote STU, intelligible audio is presented to the party using the remote STU. The same process is used to encrypt and decrypt the remote secure device to local secure device path. If the correct pseudo-random bit used in the encryptor is matched in the decryptor with the correct bit in the encrypted data or voice bitstream, the secure devices are “bit synchronized”, have “bit count integrity”, and are “crypto-locked”. If the connection between the bit synchronous or secure devices, including STUs, provides “bit count integrity,” the secure devices will be able to remain “bit synchronized.” If the correct pseudo-random bit used in the encryptor is not matched in the decryptor with the correct bit in the encrypted data or voice bitstream because the connection between the secure devices does not preserve bit count integrity, the secure devices become unsynchronized and lose crypto-lock. In a STU, loss of crypto-lock results in a meaningless output from the decryptor to the voice compression decoder, and useless noise when the decoded voice signal is converted to analog form. Similarly, after loss of crypto-lock, the output from a remote secure device in data mode is corrupted data (“garbage”); after loss of bit synchronicity, the output from a remote, non-secure, bit synchronous device usually contains errors until sync is restored.

Secure calls are established using STUs in the same general method as described above for secure devices. Specifically, each STU has a seed key associated with a given STU. The block cipher used to protect the rule exchanged during secure call setup is known as an operational key, and the stream cipher used to protect the streaming bitstream (voice, fax, or data) is known as a traffic encryption key. Using STUs, when local to remote, and remote to local, secure signal paths obtain crypto-lock, the voice path between the calling and called parties is reopened using the secure signal path. Secure signal path set-up takes several seconds when using a STU-III. The local and remote parties have the option of switching back and forth between secure and non-secure modes, but each re-entry into secure mode incurs a secure path set-up delay, during which time the local and remote parties cannot communicate. STU specifications require a bit error rate of 1×10⁻⁴ or better to maintain crypto-lock. The voice decoder in a STU-III can detect a loss of crypto-lock in voice mode and automatically initiate resynchronization of the cryptographic modules. A STU-III compliant device in data mode, however, cannot detect a loss of crypto-lock.

The U.S. government originally developed STUs as a means to protect voice and data sent over the public switched telephone network (“PSTN”). The use of STUs began when circuit-switching was the primary means of call completion and most network trunks and lines were analog. Even though backbone trunks, edge trunks (i.e., trunks from a tandem switch to a serving switch), and many end-user lines are now digital, STU-IIIs and similar secure devices (i.e., those using the same internal architecture of STU-IIIs) have retained a modem interface to the network. Several hundred thousand STUs and similar secure devices are currently deployed in the U.S. government (primarily in the Department of Defense) and will remain in service for years to come. Commercial versions of the STU-II are used by businesses, foreign governments, and other organizations. The “STU-IIB” terminal is used for secure communications by participating North Atlantic Treaty Organization (NATO) governments. Several companies in the U.S., Europe, and Australia manufacture secure devices that have the same general architecture, processing, and operating modes as STUs and are included in term “similar secure devices” used herein. The maximum datarate of most STU-III and similar secure devices is 9.6 Kbps. The term “similar device” as used herein means a digital device that requires a bit synchronous communications path between local and remote devices, i.e., a non-encrypted synchronous data communications device.

The process of adapting an analog signal designed for circuit-switched networks for use over low datarate transmission paths is called an “interworking function” (“IWF”). The first IWFs were designed for digitally compressed-voice and compensated for the fact that the modulated (i.e., modem) output of a STU or similar secure device could not be reliably quantized and transported over a transmission path of less than 32 Kbps. These first IWFs converted the STU encrypted and modulated output back to an encrypted bitstream, formatted the bitstream, and carried such bitstream over a digital transmission path that provided a bitstream datarate equal to or greater than the STU bitstream datarate; at the receiving end or at an intermediate point, a second IWF performed the reverse process.

With the proliferation of packet networks, STUs and similar devices have encountered a new problem, an “internetworking” problem that affects both secure devices and similar devices. When one or more packet network links are introduced in the transmission path between local and remote devices, certain effects of packet network protocols and signal processing can adversely affect the operation of STUs and similar devices (which, as discussed above, are designed for circuit switched networks). The term “packet network” includes Internet Protocol, Asynchronous Transfer Mode, Frame Relay, X.25, SONET, SDH, and other network technologies in which transmitted content is packetized and/or framed. Unlike circuit-switched networks, which establish an unshared end-to-end communications path, packet-switched networks packetize all traffic, and may use different, shared transmission paths for different packets within the same call. If packets carrying a secure or bit synchronous call are delayed, dropped, duplicated, or out of sequence, synchronization between the local and remote devices can be disrupted, causing loss of crypto-lock; loss of crypto-lock results in garbage output. In secure data modes, there is no context inherent in the bitstream itself in which to detect a loss of synchronization, so secure devices will continue to exchange garbage until one party or software process forces the secure devices to resynchronize, usually by leaving and reentering secure mode. For unattended secure devices, the results of long-term loss of crypto-lock can be disastrous.

The increasing use of packet networks, particularly Internet Protocol packet networks, means that the problem of crypto-lock loss and consequential call failure is increasing. If packets are delayed or dropped (lost in the network, or discarded after detection of bit errors in the packet), the incoming bitstream received by a secure communications device or similar device momentarily stops, bit synchronicity is disrupted, crypto-lock is lost, and the secure or other bit-synchronous call fails. If packets are duplicated, the content received differs from the content transmitted from the sending party, bit synchronicity is disrupted, crypto-lock is lost, and the bit-synchronous call fails. If packets are delivered out of sequence, each mis-sequenced packet causes a burst of errors; if there are many such bursts of errors, crypto-lock can be lost and the bit-synchronous call fails. Even newer secure and bit-synchronous devices that have digital network interfaces, rather than a modem interface to an analog network, are susceptible to call failure due to the problems associated with using bit synchronous communications over packet networks.

A solution that enables the reliable use of STUs, similar secure devices, and bit synchronous devices over packet networks has proven elusive. Moreover, the scope of use of existing circuit-mode encryption devices could be substantially expanded if bit synchronicity and crypto-lock could be maintained across packet networks.

2. Description of Related Art

The closest related art to the invention teaches away from the Bit Synchronizer and Internetworking System and Method invention. U.S. Pat. No. 5,426,643, granted to Smolinske, et al., recognizes the problems arising from the use of secure devices, including STU-III phones, over one type of packet network, a Personal Communications System wireless network. Smolinske's solution to avoid loss of crypto-lock over a wireless packet network involves the use of buffer memory, locking the decryptor timing to the encryptor clock, assigning a sequential number to each transmitted bit, requesting the retransmission of errored or missing data packets, and inserting a retransmitted packet in the correct place in buffer memory. Smolinske's solution depends upon very short delays in the transmission path between the remote device requesting a retransmission and the local device providing the replacement packets. Smolinske's solution will not work over a transmission path, such as a satellite path, in which requested packets retransmitted by the local device do not reach the remote device in time, that is, before the payload of the missing packet is required for use in a decryptor or other synchronous process. The wireless packet system to which Smolinske's solution is directed also uses variable length packets. Smolinske's solution must therefore lock the decryptor timing to the encryptor clock to accommodate a variable number of bits being inserted as the payload of a packet.

Many new communications technologies, such as Voice Over Internet Protocol, Voice over Frame Relay, and backbone protocols such as ATM and Ethernet, are packet based and provide additional pressure for a solution to the secure, and bit synchronous, call failure problems arising from the use of packet networks. In particular, a broad solution is needed that that does not require capturing and transmitting timing information from a local device to a remote device or the retransmission of packets, yet accommodates delayed, missing, out of sequence, or duplicated packets. The Bit Synchronizer and Internetworking System and Method achieves these objectives.

### SUMMARY OF THE INVENTION

The Bit Synchronizer and Internetworking System and Method invention relates generally to a system and method of enabling secure or bit synchronous communication during adverse network conditions, including transiting a congested packet network, that otherwise would cause a loss of bit count integrity. Among other things, the invention enables STU-III phones and similar secure devices to be used reliably over a mixture of circuit-switched and packet-switched communications paths. The invention can also be advantageously used where connections are over only packet networks and even where connections do not involve packet networks but experience transmission delay variation because of software processing, multiplexing of internal connections, or other causes. Packet retransmission requests, retransmissions, and retransmission acknowledgements are not used by the invention.

Use of the invention requires embodiments of the invention at the local and remote terminals of a communications path, or at intermediate points in such communications path serving such terminals. Each such embodiment is called herein a Bit Synchronizer and Internetworker, or “BSI”. A “terminal” is a secure, or bit synchronous, communication device. A “local terminal” initiates a call, and a “remote terminal” answers the call. A “connection” is the combination of a transmission path from a local terminal to a remote terminal, and a transmission path from the remote terminal to the local terminal, also known as a “duplex connection”. A “simplex connection” is only one of the preceding transmission paths, either from local terminal to remote terminal, or vice versa. No later than the time that use of the invention is invoked for a given connection between local and remote terminals, the local and remote BSIs negotiate a specific data packet payload size for packets that will be exchanged between the local and remote BSIs. The link between such two BSIs may transit one or more packet networks.

In the outbound transmission path (“outbound path”) from a local, transmitting terminal to a remote, receiving terminal, the BSI accepts serial, baseband, digital input from a transmitting source such as a serial data port, the output of an interworking function used with a STU or similar secure device, or the output of the demodulator of a modem. The BSI buffers the input data and creates fixed-size packet payloads. As part of the packet assembly process, the BSI adds a “payload sequence number” in each data packet. The payload sequence number has an initial value of zero (other values can be pre-selected and used as the initial value). The BSI increments the payload sequence number by one for each packet payload up to a pre-selected maximum, then rolls the payload sequence number to zero, and continues such incrementing and roll-over iteratively during the remainder of a given call. Each iteration from lowest sequence number to highest sequence number is called a “block” of sequence numbers, the packets containing a single such iteration of sequence numbers are called a “block” of packets, and the payload data contained in a block of packets is called a “block” of data. The BSI sends each outbound packet to the outbound transmission path as soon as the packet is assembled. A similar outbound process is performed at the remote BSI for the remote terminal to local terminal transmission path.

In the preferred embodiment, when a connection is first established, the remote BSI in each outbound path creates a smoothing buffer, preferably by using fast random access memory. The smoothing buffer is sized to that it can store the payloads of a plurality of packet payloads. The absolute capacity in bits of the smoothing buffer is called the “smoothing buffer capacity”, and the number of bits actually used in the smoothing buffer is called the “smoothing buffer fill level.” The smoothing buffer is initialized by briefly holding the first few payloads of packets received from the local terminal in the smoothing buffer in the remote BSI, and in the correct sequence order based on payload sequence numbers. When the desired buffer fill level is reached, the smoothing buffer begins to output the buffered data. Alternatively, dummy data, e.g., all zeros, may be inserted into the buffer in order to achieve the desired initial fill level, without waiting for the arrival of additional packet payloads. As each packet arrives at the remote embodiment of the invention, the new payload data is extracted and inserted into the smoothing buffer at the location indicated by the associated sequence number. The number of bits in the payload of a single packet is equal to one “slot” in the smoothing buffer. The size in bits of the smoothing buffer may be smaller than a block of data. For example, if the sequence numbers range from 0 to 31, and the smoothing buffer has a total capacity equal to sixteen times the packet payload size, then the payload data from a packet with sequence number 0 or 1 would be stored in the first slot of the smoothing buffer, the payload data from packet 1 or 17 would be stored in the second slot, et cetera.

Asynchronously with inserting the payload of arriving packets into the smoothing buffer, the BSI outputs, at regular (i.e., synchronous) intervals in a bitstream, the contents of sequential slots of data from the smoothing buffer to the next stage in processing a digital inbound signal at a remote terminal, such as a serial data port, the input of an interworking function used with a STU or similar secure device, or the input of the modulator of a modem. When the end of the buffer (i.e., the last slot) is reached, output iteratively continues from the beginning (i.e., the first slot) of the buffer. A BSI integral with a remote terminal preferably locks the output of the smoothing buffer to the timing driving the decryptor or other bit synchronous process in the remote terminal. In an important alternative embodiment, the arrival time of the packet payloads received from the network by the remote BSI is used to adjust the smoothing buffer output rate to match the rate at which the local BSI is sending data into the network, in which case the remote terminal timing (i.e., the decryptor timing in a secure device) is locked to the remote BSI timing.

If a packet payload is not received prior to the time at which the corresponding data slot in the smoothing buffer is output, then old or dummy data will appear in the output stream for the duration of that slot. If it is desired to use dummy data in this situation, then each slot is overwritten with dummy data after it is read. If it is desired to use old data, then no special action is necessary. Thus, the BSI avoids smoothing buffer underrun (absence of data arriving from the local terminal in a connection), whether the underrun is caused by lost, duplicated, delayed, or out of sequence packets, and maintains bit synchronization, which in turn avoids the loss of crypto-lock by secure devices and the loss of bit count integrity by other bit synchronous devices.

The BSI invention replaces the payload of all packets that are lost, discarded due to errors, or excessively delayed with dummy bits or with “leftover” bits. The listener in a voice call, or end-user application, will receive a burst of errors for the duration of the dummy or reused payload, but the remote terminal will remain bit-synchronized. Packets that are duplicated or arrive out of sequence will have no effect on the output data stream. For the BSI invention to be used effectively in a specific application, the frequency of these error bursts, and the overall delay of the network connection, must be limited to a level that the receiving device will tolerate.

### BRIEF DESCRIPTION OF THE DRAWINGS

FIG. 1 is a schematic diagram for a system configured to provide secure communications over a packet network, according to one embodiment.

FIG. 2 is a flow diagram illustrating the bi-directional nature of the interworking function and embodiment function, according to one embodiment.

FIG. 3 is a flowchart of processing in the sequencer in a local BSI, according to one embodiment.

FIGS. 4-A through 4-D illustrate data formatting produced by the sequencer at a local BSI, according to one embodiment.

FIG. 5 is a flow diagram detailing the embodiment process at the remote BSI, according to one embodiment.

FIG. 5A is a diagram detailing the operation of a circular smoothing buffer.

FIG. 6 is a timing diagram illustrating how lost data is repaired at the remote BSI, according to one embodiment.

FIG. 7 is a timing diagram illustrating how duplicated data is repaired at the remote BSI, according to one embodiment.

FIG. 8 is a timing diagram illustrating how data received out of sequence is repaired at the remote BSI, according to one embodiment.

FIG. 9 is a timing diagram illustrating how delayed data is repaired at the remote BSI, according to one embodiment.

FIG. 10 is a diagram illustrating an alternate, linear smoothing buffer design at a remote BSI, according to an alternative embodiment.

FIG. 11 illustrates a system in which an interworking module and a BSI are integrated in each of two statistical multiplexers and used with secure telephones in a satellite communications network.

FIG. 12 illustrates a system in which an interworking module and a BSI are integrated in each of two frame relay access devices and used with secure telephones in a satellite communications network.

FIG. 13 illustrates a system in which an interworking module and a BSI are integrated in each of two voice over Internet Protocol interfaces and used with secure telephones in a packet communications network.

FIG. 14 illustrates a system in which an interworking module and a BSI are integrated in each of two voice over Internet Protocol interfaces and used with circuit mode data devices in a packet communications network.

FIG. 15 illustrates a system in which a voice encoder/decoder, cryptographic module, BSI, and a packet network interface are integrated in each of two packet secure phones and used in a packet communications network.

### DETAILED DESCRIPTION OF THE PREFERRED EMBODIMENTS

The Bit Synchronizer and Internetworking System and Method is described in terms of system architecture, then in terms of the functional modules, the preferred embodiment, and alternative embodiments.

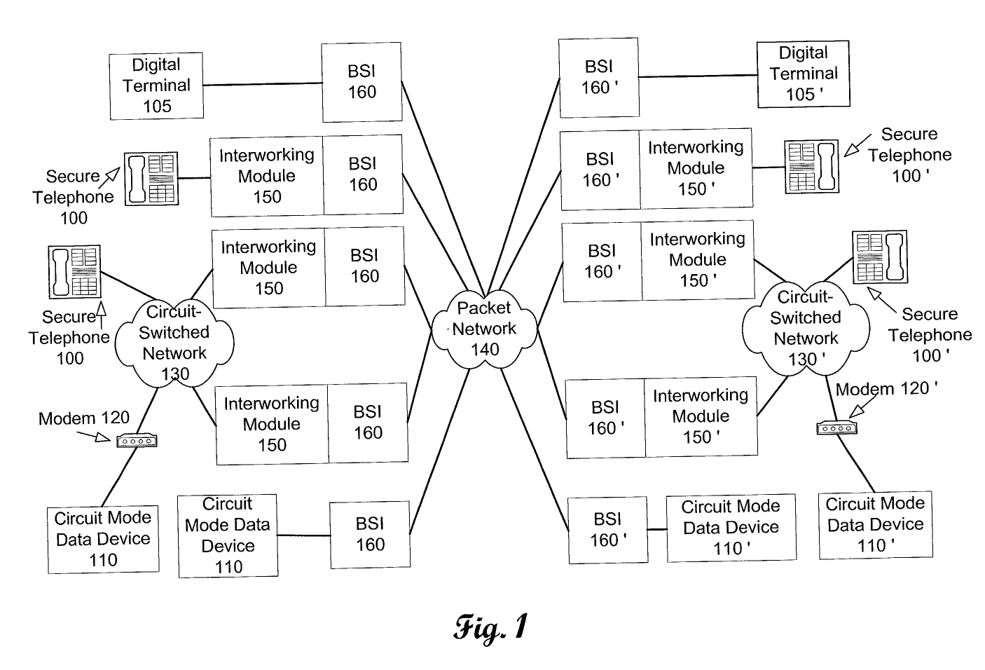

FIG. 1 depicts an architecture that allows a local terminal, such as an analog interface secure telephone 100, digital interface terminal 105, or circuit mode data device 110, to communicate with a remote terminal, such as an analog interface secure telephone 100, digital interface terminal 105, or circuit mode data device 110. Normally, data flows are full duplex (bidirectional), as in a traditional voice call. The Bit Synchronizer and Internetworking System and Method also works in half duplex mode, i.e., where the connection has only a single direction, as in a video monitoring application.

The Bit Synchronizer and Internetworking System and Method is primarily directed toward enabling reliable secure and other types of bit synchronous connections over communication paths that involve the use of one or more packet networks 140 for at least part of the end-to-end communication paths. The secure telephone 100 may be a STU-III, STU-IIB, or other analog interface secure telephone or bit synchronous device. Circuit mode data device 110 may be a facsimile machine or other data terminal with an analog interface that uses a modem 120 and circuit switched signaling. Most circuit mode terminals currently use a circuit-switched network 130 to access intermachine trunks in a Public Switched Telephone Network (PSTN), or a private network

Packet network 140 may be, or include any one or more of, an Internet Protocol (IP)-based public network like the Internet, an intranet, a private IP-based network, a Personal Area Network (PAN), a local area network (LAN), a wide area network (WAN), a metropolitan area network (MAN), a frame relay network, a Synchronous Optical Network (SONET), an Ethernet, an Integrated Services Digital Network (ISDN), a digital cable line, an ATM network, or Fiber Distributed Data Interface (FDDI)-based network, or a Copper Distributed Data Interface (CDDI)based network. Packet network 140 may furthermore be or include any one or more of wireless packet technologies, such as a General Packet Radio Service (GPRS) link, Cellular Digital Packet Data (CDPD) link, a Bluetooth™ or IEEE 802.11 radio link, or any other wired or wireless network configured to operate using packets.

There are several network parameters that must be considered in any specific application of the BSI invention: average packet delay, packet delay variability, and packet loss rate. Packet networks statistically multiplex data from multiple sources into common packet streams. This multiplexing causes variation in the time required to transit the network, as packets wait in queues until they are place in the multiplexed stream. The time variation becomes larger as the overall network traffic increases.

Most full-duplex secure devices, such as STU-III telephones, have timers built into their modem training and cryptographic synchronization protocols which limit their tolerance for delay in the connection path between local and remote devices. If the overall delay, which consists of the network delay, the BSI buffering delay, and the IWF delay (if applicable), is too large, then the modem training and cryptographic (or other bit synchronization) timers in the local and remote devices will time out and the devices not be able to synchronize and communicate. The network delay can be minimized, in some networks, by employing “quality of service” (QOS) protocols to give priority to certain connections. The BSI delay can be reduced by setting a smaller initial smoothing buffer fill level, but this increases the probability that some packets will arrive after the slots allocated to the payload of those late packets have been read from the smoothing buffer.

In a given network, if the packet delay distribution is well known, then it is possible to size the smoothing buffer fill level to accommodate a certain probability of packet loss due to late arrival. For example, if the minimum time for a packet to transit the network is 1 second, and 99.9% of all packets have a transit delay less than 1.5 seconds, then a smoothing buffer fill level of at least 0.5 seconds will reduce the probability of “late arrival packet loss” to 0.1%.

Packets may be lost due to bit errors while transiting the network, or may be lost due to congestion in the network. The BSI replaces lost packet payloads, and preserves bit synchronization, until excessive packet loss interferes with normal operation of the local and remote devices. Packet losses due to congestion can, in some networks, be reduced by reserving bandwidth for connections carrying BSI traffic, either by the static configuration of network elements or by appropriate use of QOS protocols.

If the output stage of an end-user terminal, such as that of a secure telephone 100, contains or is a modem, the terminal interface is analog and an interworking module 150 is necessary to perform an analog to digital conversion. In a typical use of the invention, a BSI embodiment 160 is inserted between the digital interface of an interworking module 150 and a packet network 140. If a digital interface end-user terminal 105 is used, interworking module 150 is not needed and digital terminal 105 interfaces directly through BSI 160 to packet network 140. Interworking module 150 and/or BSI 160 may be implemented as a hardware device or in software that operates on one or more processors located at an end-user terminal, or at one or more gateways in an end-to-end communication path. To practice the invention, a BSI 150 is associated or integral with each local and remote terminal 100, 105, 110 in a communications path, or provided at intermediate or “gateway” points (not illustrated in FIG. 1) in such communications path serving such terminals. The network side of each BSI 150 interfaces with an OSI Layer 2 or Layer 3 addressing device or process (not illustrated) that communicates with packet network 140 in a manner well known in the art.

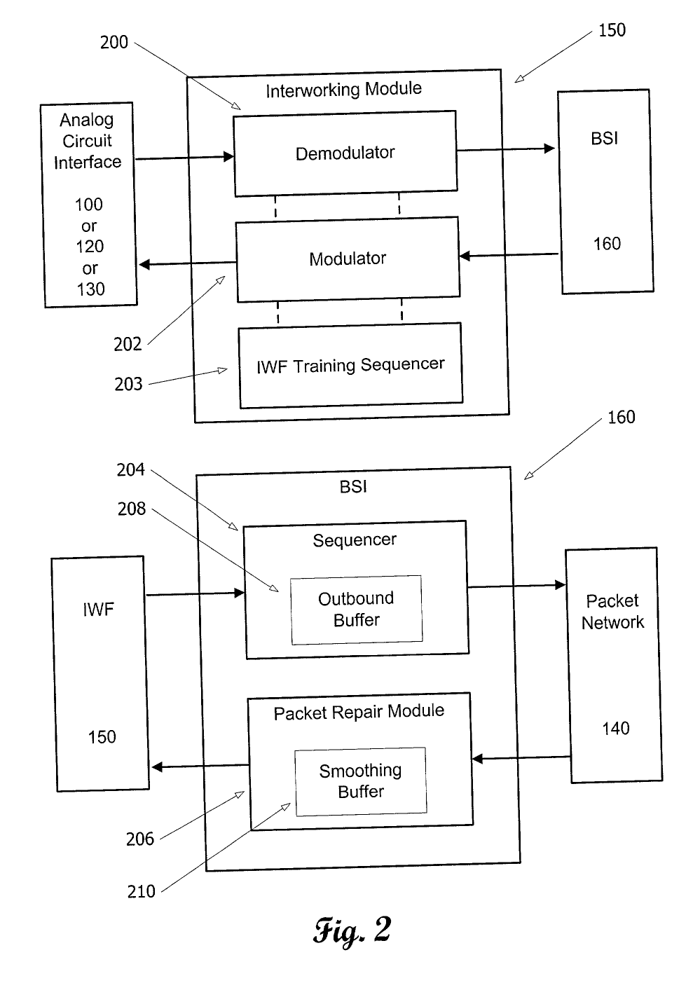

FIG. 2 illustrates the bidirectional operation implemented with an optional interworking module 150 (required only with analog interface terminals) and BSI 160, according to one embodiment. The interworking function, or IWF, is performed by interworking module 150, sometimes called herein an “IWF module” or simply “IWF”. An IWF performs analog to digital conversion in the outbound path, and a digital to analog conversion on the inbound path, of the terminal with which the IWF is interfaced; an IWF can also limit the datarate provided to a modem interfaced with the IWF based on the datarate available to the IWF through the IWF's interface to a network or to a BSI. An IWF associated with a local terminal is normally capable of exchanging training and control messages with an IWF associated with a remote terminal. As illustrated in FIG. 2, in interworking module 150, demodulator 200 converts a modulated voiceband, analog signal from secure phone 100, modem 120, or other circuit mode analog device into an outbound baseband digital bitstream. In the other direction, modulator 202 converts an inbound baseband, digital bitstream into a voiceband, analog signal. Interworking module 150 may further include an IWF training sequencer 203. When analog interface terminals are connected through an IWF over a circuit switched digital network with transmission paths of 32 Kbps or greater, the IWF training sequencer in the interworking module 150 is bypassed and all modem training is conducted end-to-end (from one analog interface terminal to the other). When network transmission paths are less than 32 Kbps, the IWF training sequencer of interworking module 150 is inserted and some aspects of modem training (e.g., echo canceller training) are accomplished “locally” (proximally) between the modulator 202 and demodulator 200 of interworking module 150 and the analog interface of the proximal terminal 100, 120. Other aspects of the modem training (e.g. datarate negotiation) must be conducted end-to-end. The function of the IWF training sequencer 203 is to coordinate the proximal and end-to-end aspects of modem training. A first, local IWF training sequencer 203 associated with a local BSI 160 (in FIG. 1) communicates with a second, remote IWF training sequencer 203 associated a remote BSI 160′ when managing end-to-end aspects of the modem training.

As shown in FIG. 2, BSI 160 includes, among other things, a sequencer 204 and a packet repair module 206. Sequencer 204 further includes an outbound data buffer 208. Packet repair module 206 further includes a smoothing buffer 210. Data buffers 208 and 210 may be permanent, or they may be created on an as-needed basis in random access memory. The digital link between each BSI and the terminal associated with it can be short, for instance, when the BSI is integral with a STU-III telephone, or it can be longer, for instance, when the BSI is located at a intermediate node in a digital network (e.g., at a statistical multiplexer interfaced with a packet network, or at a satellite communications gateway node), so long as (i) overall delays are within modem training or terminal buffer limits (collectively called the “delay tolerance” of the remote terminal), and (ii) the bit error rates (“BER”) on the BSI to associated terminal link are acceptable (typically a BER of 1×10⁻⁴ or better). The datarate of the link between each BSI and the terminal it serves is the datarate negotiated between the local and remote terminals during modem training for analog terminal interfaces or during path negotiation for digital terminal interfaces. Typically, when a BSI is associated through an IWF with an analog interface terminal, BSI operation is invoked upon completion of modem training (a modem is the network interface of an analog interface terminal).

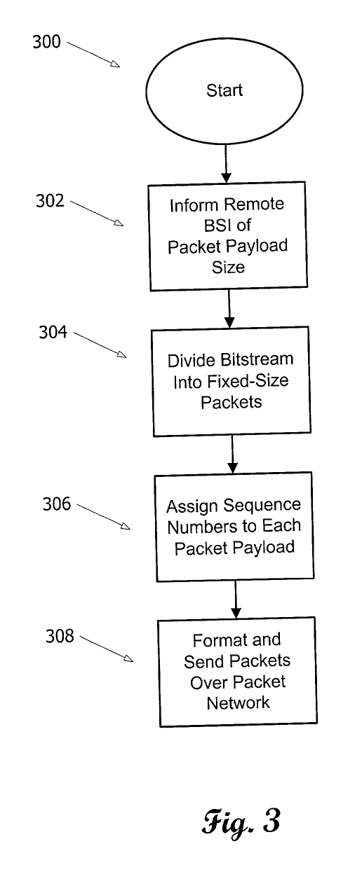

As shown in FIG. 3, no later than the time that use of the BSI is invoked for a connection between a pair of local and remote terminals, the local BSI informs 302 the remote BSI of a specific, fixed size of each data packet payload that will be exchanged between the local and remote BSIs. The sequencer divides 304 the local device outbound bitstream into fixed-size payloads conforming with the specified size, and assigns 306 a sequence number to each packet payload. Each payload and associated sequence number is then formatted 308 into packets using OSI Layer 2 and/or Layer 3 methods known in the art and transmitted 308 over a packet network. In the preferred embodiment, the packet payload size is set by the user or by application software; in this embodiment, packets are transmitted only after all bits needed to fill the payload for a given packet are received by sequencer 204. Alternatively, the payload packet size can be fixed according to the modem datarate so that, for example, each packet payload corresponds to a fixed time period, regardless of the actual bits of payload inserted into a packet. In this alternative embodiment, the packet payload size is set as a function of the datarate negotiated by the local and remote terminals (and any associated IWFs), so no initial specification of a fixed packet payload size by the local BSI, or additional negotiations or control communication, is required between the local BSI and the remote BSI; determining the packet payload size used by the local and remote BSIs depends solely on the negotiated datarate, a parameter that is available to a given BSI from the terminal associated with that BSI. A secure voice system now deployed in a satellite network uses this alternative embodiment The fixed payload size (time period) in that system is normally 20 milliseconds, as determined by the datarate negotiated during modem and IWF training. As described above, the IWF associated with a given BSI can negotiate the datarate of a connection, in which case the local IWF informs the local BSI of the selected datarate, and the remote IWF informs the remote BSI of the selected datarate.

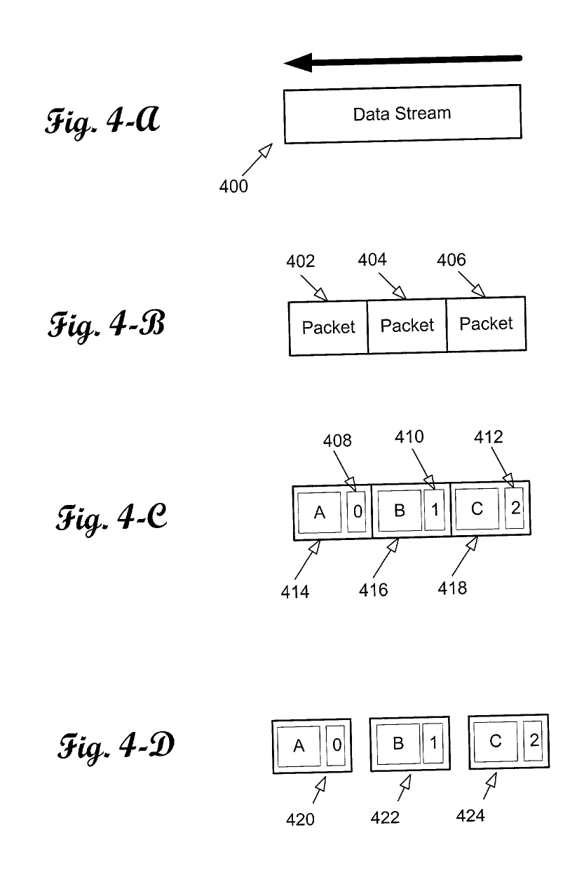

FIGS. 4-A through 4-D illustrates how data is reformatted by sequencer 204 before it is communicated over packet network 140. In the outbound transmission path (“outbound path”) from local, transmitting terminal to remote, receiving terminal, the local BSI accepts serial, baseband, digital input from a transmitting source such as a serial data port, the output of an IWF module used with a STU or similar secure device, or the output of the demodulator of a modem (such as a modem used to demodulate the output of a Group III fax machine). Sequencer 204 starts in step 300, shown in FIG. 3, by receiving a bitstream 400, shown in FIG. 4-A, from the output of the local transmitting source. In step 302, sequencer 204 informs the remote BSI of the packet payload size to be used on the outbound path. The local BSI buffers the outbound data in the outbound buffer 208 and creates data packets, shown in FIG. 4-B, in the specified size, each containing a fixed number of bits as payload. Such packets are called “fixed-size payloads”. In an alternative embodiment of the BSI, step 302 entails negotiation of a fixed payload size by local and remote BSIs, rather than specification of packet payload size solely by the local BSI. In an alternative embodiment of the BSI, selection or calculation of the fixed payload size to be used for a portion of a call, and the transition point to a different payload size, can be periodically negotiated by local and remote BSIs based on the available bandwidth of the packet network or according to other criteria; in this alternative embodiment, if a larger payload size is to be negotiated, both BSIs must have the necessary smoothing buffer capacity to accommodate a larger payload size at a given datarate. Higher throughput, which is facilitated by larger packet payloads and larger smoothing buffer capacity, is usually more important in data communications than in voice communications.

In step 304 (in FIG. 3), a bitstream 400 (in FIG. 4-A) is divided into packets of the specified fixed size, known as the packet payload. The resulting data format is illustrated in FIG. 4-B as payloads 402, 404, and 406. In step 306, a payload sequence number is assigned to each packet payload. As shown in FIG. 4-C. each packet payload and its assigned sequence number are then assembled and fed in sequence into outbound buffer 208 (in FIG. 2). The payload sequence number has an initial value of zero (other initial values may be pre-selected and used). Sequencer 204 increments the payload sequence number by one for each packet payload up to a pre-selected maximum (i.e., the block size), then rolls the payload sequence number to zero, and continues such incrementing and roll-over iteratively during the remainder of a given call. FIG. 4-C illustrates the result, where sequence numbers 408, 410, and 412 have been appended as headers to packet payloads 414, 416, and 418, respectively. The effect of step 306, shown in FIG. 3, is depicted in FIG. 4-C, where the values of sequence numbers 408, 410, and 412 are 0 (zero), 1 (one), and 2 (two), respectively. In step 308, shown in FIG. 3, the assembled packets are further formatted by sequencer 204 to add OSI Layer 2 or Layer 3 addressing. FIG. 4-D shows the results of step 308, where, for example, packet 420 conforms with the proper network protocol and addressing for transmission of packet 420, which includes payload 414 and sequence header 408, over a packet network. The local BSI sends each outbound packet to the outbound transmission path as soon as step 308 completes the assembly and formatting of the packets. Steps 304, 306, and 308 are performed iteratively as new data arrives from the transmitting source. A similar process is performed at the remote BSI in the remote to local transmission path. The operation of sequencer 204 (in FIG. 2), as elucidated above by reference to FIGS. 3 and 4, is called “sequencing”.

In addition to sending control messages that specify payload size, BSIs can be constructed to exchange additional control messages over a connection, analogous to the exchange of setup messages by modems during modem training. The basic BSI control message is the specification of packet payload size. In an alternative embodiment, the IWF module associated with a BSI informs the BSI of the datarate for a new connection, and the BSI sets the packet size based on that datarate.

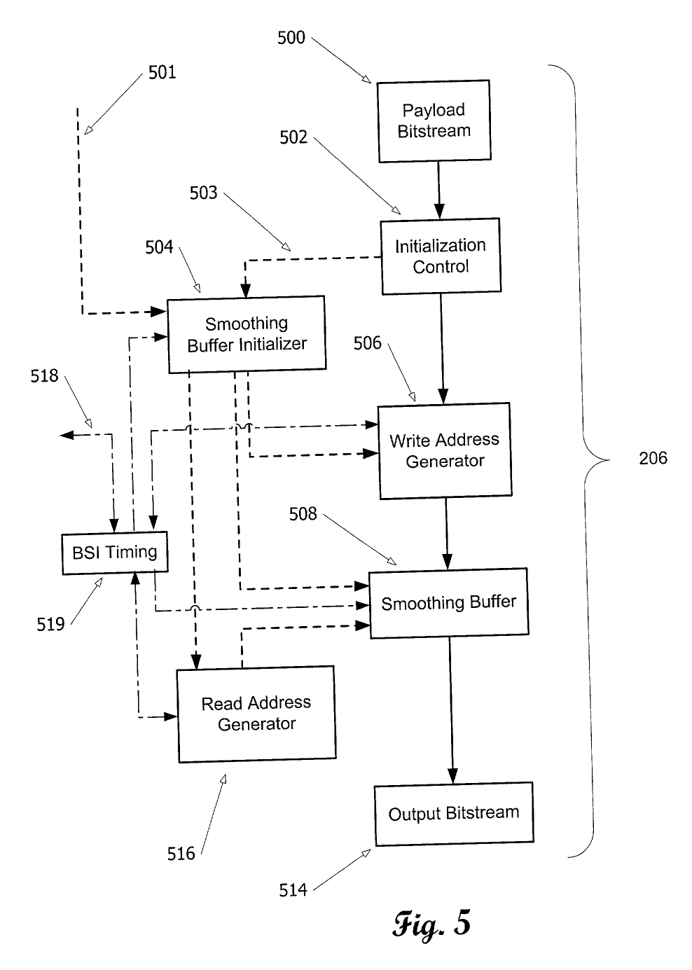

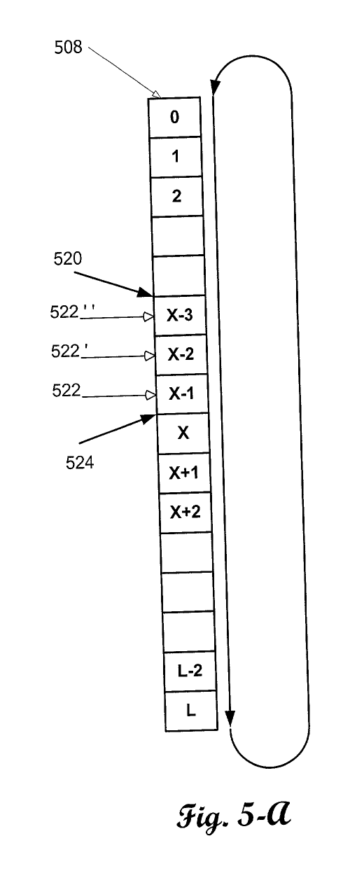

With reference to FIG. 5, the payload and sequence number of each received packet is extracted in a manner known in the art and fed into the payload bitstream 500 entering the packet repair module 206. In the preferred embodiment, operation for a given connection begins immediately before the receipt of the first received payload and sequence number, when a smoothing buffer initializer 504 in the packet repair module 206 of the BSI serving the remote terminal receives from the local BSI a BSI control message on a control channel (501). The message specifies the fixed packet payload size to be used in the connection from the local BSI to the remote BSI, as described above. When the initialization control function 502 detects the first packet payload received after a connection has been set up, the initialization control function 502 sends both a “start” message and the sequence number extracted from the first received packet to the smoothing buffer initializer 504. The smoothing buffer initializer 504 sends a control message to smoothing buffer 508 to create a smoothing buffer, sends a control message to the write address generator 506 (“input pointer”) to write the first packet payload in the payload bitstream 500 to the appropriate slot within the smoothing buffer 508 based on the sequence number of the first payload, and sends a control message to the read address generator 516 to read from smoothing buffer 508 at the address (“output pointer”) a specified number of slots offset from the first write address. The difference between the input pointer address and the output pointer address is the smoothing buffer fill level. The smoothing buffer level, in bits, is normally set to an integer multiple of the slot size. The slot size is equal to the number of data bits in the payload of a packet conforming to the negotiated packet size. Further, the number of slots in the buffer is normally chosen to be the sequence number block size divided by some integer. With this arrangement, a payload with sequence number N is always written to slot M of the smoothing buffer, where M=(N modulo L), where L is the length of the smoothing buffer in slots. The initial fill level of the smoothing buffer is normally based on the negotiated payload size, the datarate of the transmission path, the expected network delay variation, and the delay tolerance of the remote terminal. Thereafter, as each payload and sequence number arrive at the remote BSI in payload bitstream 500, the payload from the received packets is written to the smoothing buffer 508 at the location determined by the write address generator 506 based on the sequence number of a given packet payload.

As shown in FIG. 5, timing is supplied by the BSI timing control function 519 to the smoothing buffer initializer 504, the write address generator 506, the smoothing buffer 508, and the read address generator 516. In connections unaffected by smoothing buffer underrun or overrun, BSI timing control 519 is sourced from the decryptor or other bit synchronous clock source 518 in the remote terminal. The read address generator 516 causes bits to be output in sync from the smoothing buffer into the output bitstream 516 by incrementing the output pointer one bit or one word per timing interval, depending upon whether the output bitstream is serial or parallel (where a word is the number of bits which are moved in each transfer). Thus, asynchronously with inserting the payload of arriving packets into the smoothing buffer, the packet repair module 206 outputs, at synchronous intervals in a bitstream, the contents of sequential slots of data from the smoothing buffer to the next stage in processing a received bitstream in a remote terminal, such as a serial data port, the input of an IWF module used with a STU or similar secure device, or the input of the modulator of a modem. When the end of smoothing buffer 508 is reached (i.e., the last bit of the last slot in one iteration of reading the smoothing buffer), output iteratively continues from the beginning (i.e., the first bit of the first slot) of the smoothing buffer. This is known as a “circular buffer” design.

As shown in FIG. 5-A, which illustrates a circular buffer design, the smoothing buffer initializer, by a command to the read address generator, sets the address of the read, or output, pointer 520 of the smoothing buffer to a location some number of slots 522 through 522′, or packet payload widths, offset from the address of the write, or input, pointer 524. FIG. 5A illustrates a state in which 3 slots, associated with sequence numbers X, X+1 and X+2, in a new connection have been written into the smoothing buffer. If the delivery of data to the output bitstream is started immediately after the first packet payload is received, then the read pointer will be pointing to a slot containing either dummy data or leftover data from a previous connection, and the contents of a number of invalid data slots will be delivered to the output bitstream until the read pointer reaches the start of the first received payload in the current connection. The delivery of data to the output bitstream can be initially delayed by an amount equal to the initial fill level of the smoothing buffer in order to prevent delivery of any invalid data after smoothing buffer initialization. The “circular buffer” shown in FIG. 5-A is an aid for conceptualization. In reality, the read pointer moves through an address space, rather than the slots moving past a static read point. The operation of the smoothing buffer initializer, write address generator, read address generator, and smoothing buffer, as elucidated above by reference to FIGS. 5 and 5-A, is called “ordering”.

If a packet is lost or excessively delayed, then the read pointer of the smoothing buffer 508 (in FIG. 5) will reach a slot that does not contain current data. The leftover, or “reused” contents of that slot will be delivered to the output bitstream 514, causing a burst of errors, but without a loss of bit synchronization, since the next valid payload will be output at the correct position in the output bitstream 514. After data is read from the smoothing buffer 508, it can be replaced by dummy data, if the embodiment requires that dummy, rather than leftover, data be output in the absence of valid data. If the embodiment allows that old data (i.e., leftover, or “reused” data) be output in the absence of valid data, then the step of overwriting the data with dummy data is not necessary. Payload sequence numbers are used only to control the insertion of packet payloads in smoothing buffer 508, and are not passed to the output 514 of packet repair module 206. Thus, BSI embodiments avoid smoothing buffer underrun, whether the underrun is caused by lost, or delayed packets, and maintain bit synchronization, which in turn avoids the loss of crypto-lock by secure devices and the loss of bit count integrity by other bit synchronous devices. In addition, BSI embodiments repair any data errors due to duplicated or out of sequence packets, since the payloads of such packets are always written to the correct location in the smoothing buffer 508 (assuming each such out of sequence packet arrives and is written to the smoothing buffer before the relevant slot is read).

In the preferred embodiment, the output bitstream 514 from the BSI at the remote terminal is locked to the timing of the decryptor or other bit synchronous process in the remote terminal. In prior art devices, local terminal clock phase information must be provided to a remote terminal when variable length payloads are used. In the BSI invention, however, fixed-size payloads are used, and the arrival time of the payloads received from a network can be used as a reference to derive the necessary output clock, by phase locked loop or other techniques which are well known in the art of data communications. Write address generator 506 calculates the rate at which payloads are arriving (adjusted for missing or duplicated payloads). Timing control function 519 can determine the required output datarate by multiplying the payload arrival rate by the payload size. This datarate calculation and correction can be omitted in cases where the remote device and network (incoming payload) clock rates are sufficiently accurate that bit synchronization can be maintained over the normal duration of a secure call or other terminal session. Alternatively, the timing control function can correct for differences in the remote device and network clock rates by adjusting the read pointer of the smoothing buffer. This will cause a loss of bit synchronization, but it will be an infrequent (and periodic) occurrence which may be tolerable for the devices connected to an embodiment of the BSI. The period of such smoothing buffer adjustments will be determined by the difference between the network and device clock rates, and by the size of the adjustment. When such a smoothing buffer adjustment occurs, a “resynchronization”, or resync, is required. Some terminals provide an external interface to initiate a resync. If such an interface exists, then the BSI can command the local terminal to initiate a resync.

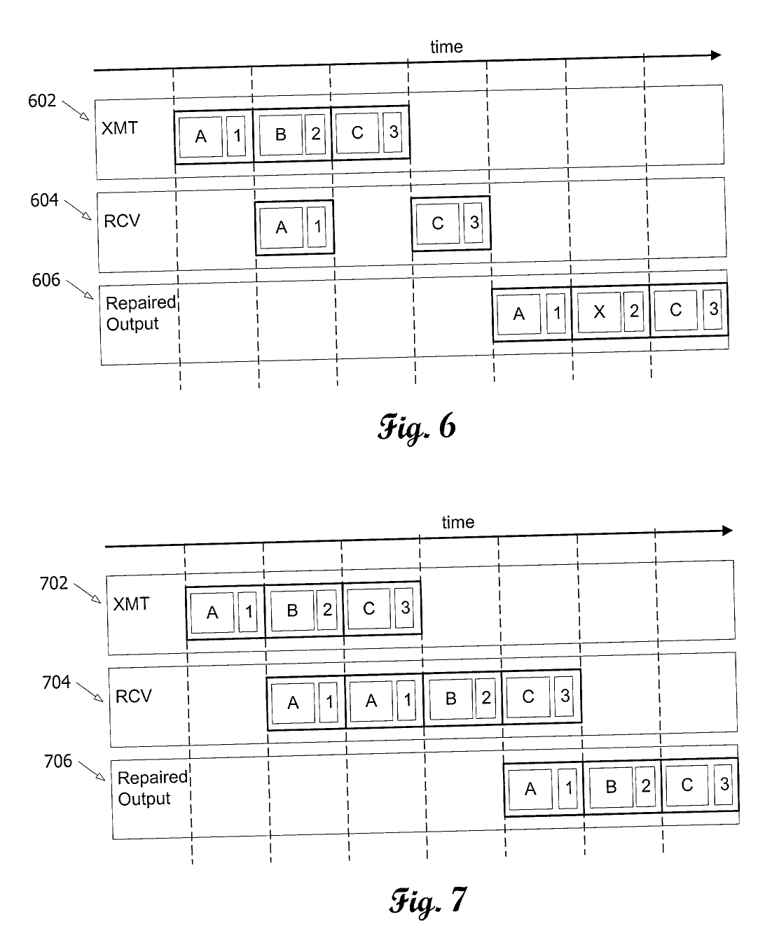

FIGS. 6-9 further describe packet repair module 206 (in FIG. 2) by presenting timing diagrams that show, among other things, how data received into buffer 210 may be transformed into a repaired output. In these Figures, an initial payload sequence number of one (1) is used.

FIG. 6 addresses the case where a packet is lost during transmission over packet network 140 (in FIG. 1). The diagram shows three data payloads and associated sequence numbers 602 that were sent from sequencer 204 (in FIG. 2). In this case, however, received data 604 contains only two data packets. Here, packet repair in step 604 delivers a leftover or dummy payload as indicated by repaired output 606.

FIG. 7 presents the case where a packet has been duplicated during transmission over packet network 140 (in FIG. 1). In this case, an extra payload was included in received data 704 but the two copies are written to the same location in the smoothing buffer 508 by the write address generator 506, so that only one copy appears in the repaired output 706.

In FIG. 8, received data 804 is out of sequence. The write address generator 506 reorders the payloads, according to sequence numbers assigned in step 306 (in FIG. 3), to generate repaired output 806.

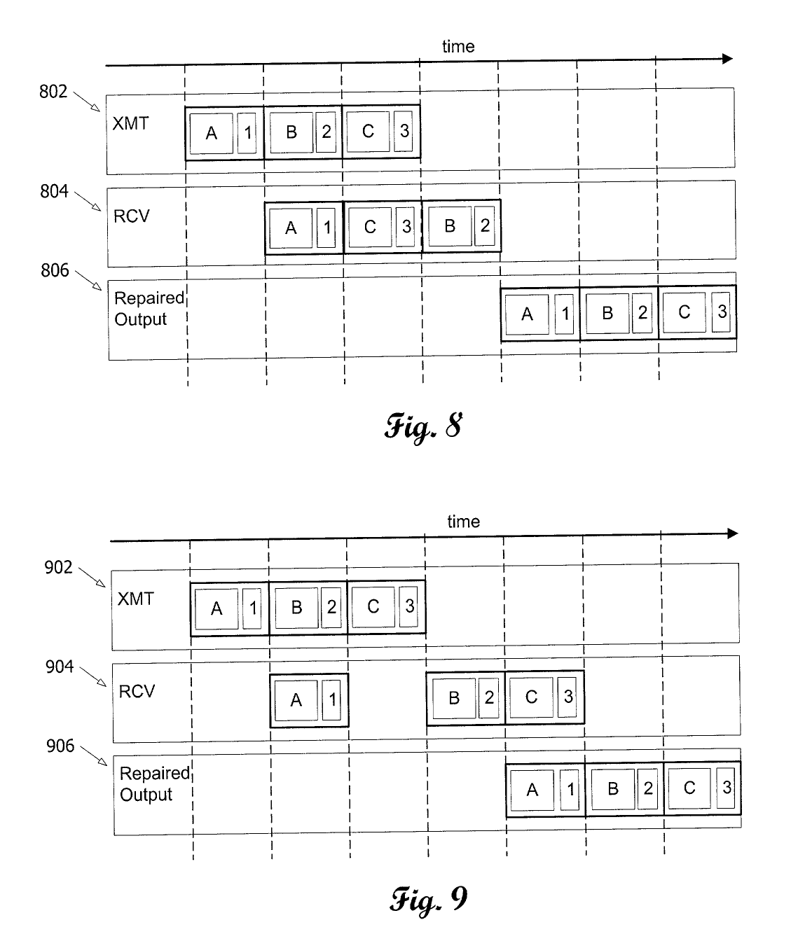

FIG. 9 depicts the case where received data 904 contains a time delay between payloads. Here, smoothing buffer 508 absorbs the delay to create repaired output 906. Repaired outputs 606, 706, 806, and 906 are all delayed somewhat from received data 604, 704, 804, and 904, respectively, as a consequence of the use of packet repair module 206, but such delay is chosen to be within the delay tolerance of the terminals or applications in use.

Although FIGS. 6-9 illustrate how four separate types of errors can be repaired, it should be understood that the correction of other similar errors, or combinations of these and other errors can also be accomplished with variations of the present BSI, as will be obvious to those skilled in the art. In the preferred embodiment, a smoothing buffer initializer 504 (in FIG. 5) in the packet repair module 206 (in FIG. 2) of the BSI serving the remote terminal receives a message specifying the fixed payload size to be used in the transmission path from the local BSI to the remote BSI. In an alternative embodiment, the smoothing buffer 508 negotiates the fixed payload size to be used in the transmission path from the local BSI to the remote BSI. Usually the packet payload size will either be set according to the datarate, so that a payload corresponds to a fixed time, or will be set by the user or by the application using the remote terminal, as described above. If a BSI embodiment with payload size negotiation were required, one BSI in a connection would sent the other BSI an offer of proposed payload sizes, and the other BSI would reply with a selection of one of those proposed payload sizes; the selected payload size would then be implemented by both BSIs in the connection.

In one embodiment of the BSI invention, the smoothing buffer fill level can be dynamically adjusted based on network conditions. In this embodiment, when a packet payload is inserted into the smoothing buffer, the write location is compared to the current output (read) pointer. If the output pointer has passed the write location (after accounting for the circular addressing), then the payload is considered late. Using input from the write address generator 506 and read address generator 516, the timing control function 519 can measure the frequency of late payloads, and can adjust the output datarate to increase or decrease the smoothing buffer fill level in order to drive the late packet frequency to a desired probability. If the actual probability of late arrival is too high, then timing control 519 would slow the output datarate, in an embodiment where the timing of the associated decryptor or bit synchronous process is slaved to the timing control function 519. The slower output datarate would cause the smoothing buffer fill level to rise, adding more slots to the smoothing buffer fill level over time, which would allow more time for late payloads to be written in the smoothing buffer, and thus reduce the probability that a payload will be replaced because of late arrival. Conversely, improved network conditions would reduce the late packet frequency, and the timing control function 519 could respond by adjusting the timing to increase the output datarate and thus decrease the smoothing buffer fill level.

As noted above, QOS protocols can be employed in some networks to reduce delay variation. In another approach to dynamic adjustment of smoothing buffer fill level based on network conditions, the smoothing buffer initializer of a BSI embodiment contains a means receiving a report of average packet delay and packet arrival variability (instead of the BSI determining such statistics internally), and the smoothing buffer initializer increasing or decreasing the smoothing buffer fill level based on reported network conditions. Dynamic adjustment of smoothing buffer fill level (i.e., “BSI delay”) based on network conditions is important in full duplex voice and video connections where reduction of overall delay improves usability.

Instead of the “circular output smoothing buffer with random access writes” embodiment described above, an alternate but functionally equivalent “linear” smoothing buffer design may be used. One embodiment of a linear smoothing buffer is a first in, first out (“FIFO”), or shift register, smoothing buffer with a sequence number counter.

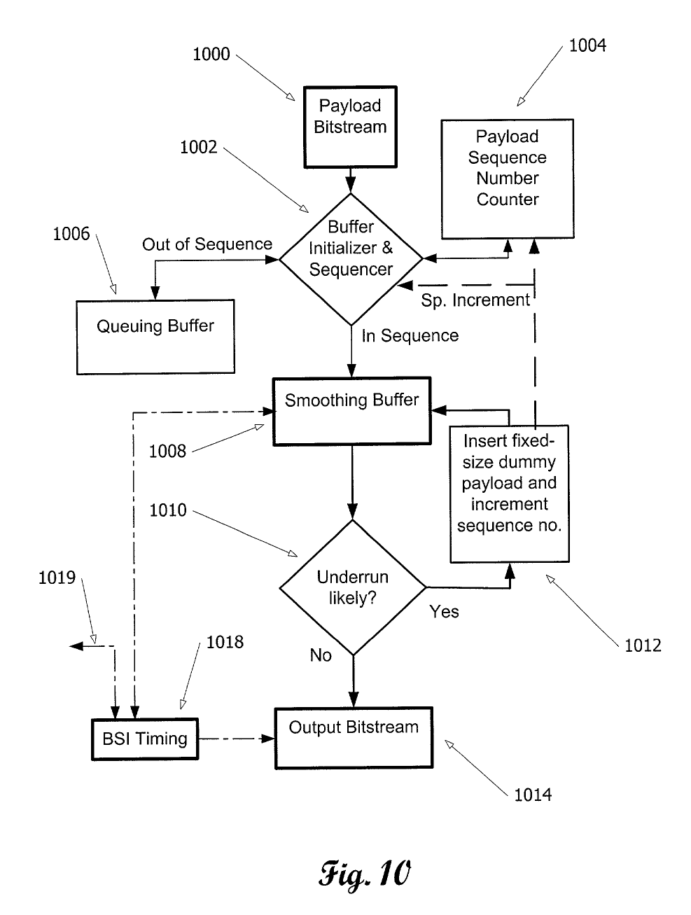

FIG. 10 shows an alternative BSI embodiment that uses a “linear” design in the smoothing buffer of the packet repair module. The linear smoothing buffer design may use random access memory. In a linear smoothing buffer design, a buffer initializer and sequencer 1002 in a packet repair module 206 of the BSI serving the remote terminal is informed of or negotiates the fixed payload size to used in the transmission path to the remote BSI, as described above. The buffer initializer and sequencer 1002 creates a smoothing buffer 1008, initializes the payload sequence number counter 1004 to zero (or other payload sequence number used by the first payload to be transmitted from the local terminal), and writes packet payloads in the smoothing buffer 1008 in the order of their payload sequence numbers. The number of bits contained in the smoothing buffer 1008, or smoothing buffer fill level, is normally based on the negotiated payload size, the datarate of the transmission path, and the delay tolerance of the remote terminal. The incoming payload bitstream 1000 is collected in smoothing buffer 1008 until buffer initializer and sequencer 1002 detects that payloads in the correct sequence and aggregating to the specified smoothing buffer fill level have been written to smoothing buffer 1008, at which point smoothing buffer 1008 begins to output data. Thereafter, as each payload arrives at the remote BSI in payload bitstream 1000, the payload sequence number of each arriving payload is tested against the next expected payload by buffer initializer and sequencer 1002 . If expected and received payload sequence numbers match, the payload is appended to the end of the most recent data in smoothing buffer 1008, and buffer initializer and sequencer 1002 increments the next expected payload sequence number in payload sequence number counter 1004 by one. If a payload arrives prior to other payloads in sequence, the buffer initializer and sequencer 1002 stores the payload with its payload sequence number in queuing buffer 1006; when the sequence number of a queued payload is reached, the buffer initializer and sequencer 1002 retrieves the payload from queuing buffer 1006 and appends it to the most recent data in smoothing buffer 1008.

The contents of smoothing buffer 1008 is constantly tested by step 1010 to determine whether smoothing buffer underrun is likely. A condition of “buffer underrun” exists if, after initialization of a buffer, the buffer outputs all data contained in the buffer before the next expected payload arrives. The threshold in step 1010 for determining whether underrun is likely is normally set to maintain some fraction of a payload in smoothing buffer 1008, with the threshold value set large enough to ensure that an underrun cannot occur before the next time the threshold test is applied (e.g., if the buffer level is tested every 5 milliseconds, then the threshold would be set to some number of bits corresponding to more than 5 milliseconds). If smoothing buffer underrun is likely as determined in step 1010, step 1012 appends to the most recent data in smoothing buffer 1008 dummy bits in number equal to the payload of one fixed-size packet as a substitute for the missing payload, and specially increments (“special”, since the increment is based on a missing payload instead of a received payload) the next expected payload sequence number in payload sequence number counter 1004 and in buffer initializer and sequencer 1002. Smoothing buffer 1008 output data flow thereby continues without loss of sync. Output from the smoothing buffer is synchronous with BSI timing reference 1018, and the timing reference is shared with the remote terminal through timing path 1019. In an embodiment utilizing random access memory for the smoothing buffer, if a missing payload arrives after a dummy payload has been inserted in its place, and there is adequate time to replace the substituted payload before such payload is read from the smoothing buffer in step 1014, the buffer initializer and sequencer 1002 inserts such payload in proper sequence in smoothing buffer 1008 to replace the dummy payload inserted in step 1012. Payload sequence numbers are used only to control the appending or insertion of packet payloads in smoothing buffer 1008, or temporary placement in queuing buffer 1006, and are not passed to the output 1014 of packet repair module 206. The operation of a linear smoothing buffer, as elucidated above by reference to FIG. 10, is also called “ordering”.

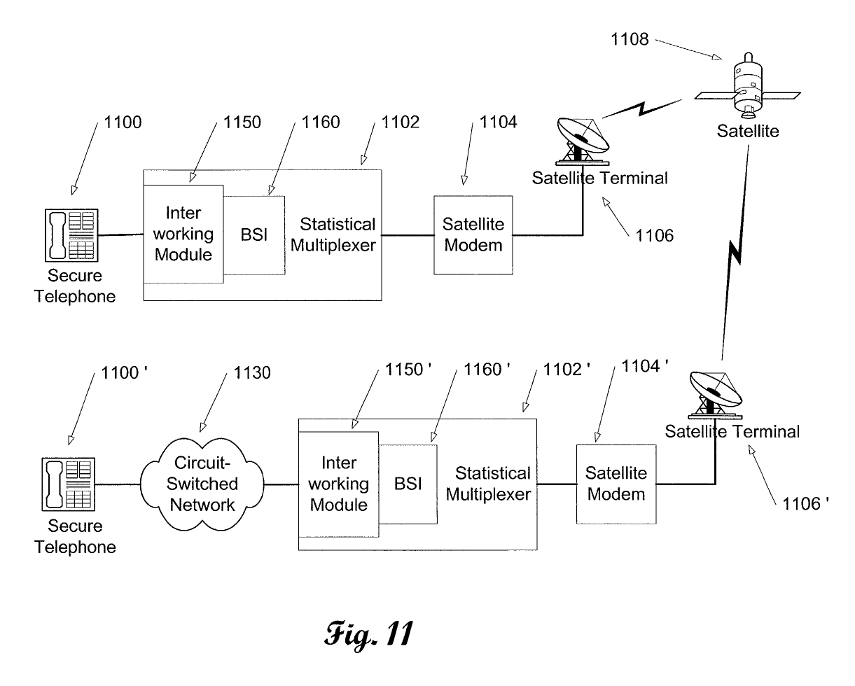

FIG. 11 depicts a system with a duplex connection using a BSI embodiment in which an interworking module 1150 and a BSI 1160 are integrated in a statistical multiplexer 1102, which communicates over a satellite link. A statistical multiplexer can combine traffic from multiple voice and data ports into a packetized, aggregate serial stream. This aggregate output outbound from statistical multiplexer 1102 is passed to a satellite modem 1104, which modulates the data into a form suitable for satellite communication. The satellite terminal 1106 amplifies the signal from the associated modem and directs it to the satellite 1108, which sends the signal back down, where it is received by satellite terminal 1104′, satellite modem 1104′, and statistical multiplexer 1102′. Secure telephone 100 is connected directly to statistical multiplexer 1102, while secure telephone 1100′ is connected to statistical multiplexer 1102′ via a circuit-switched telephone network 1130. In this embodiment, the connection to a circuit-switched telephone network may be present on one side of a connection as illustrated, on both sides, or on neither side.

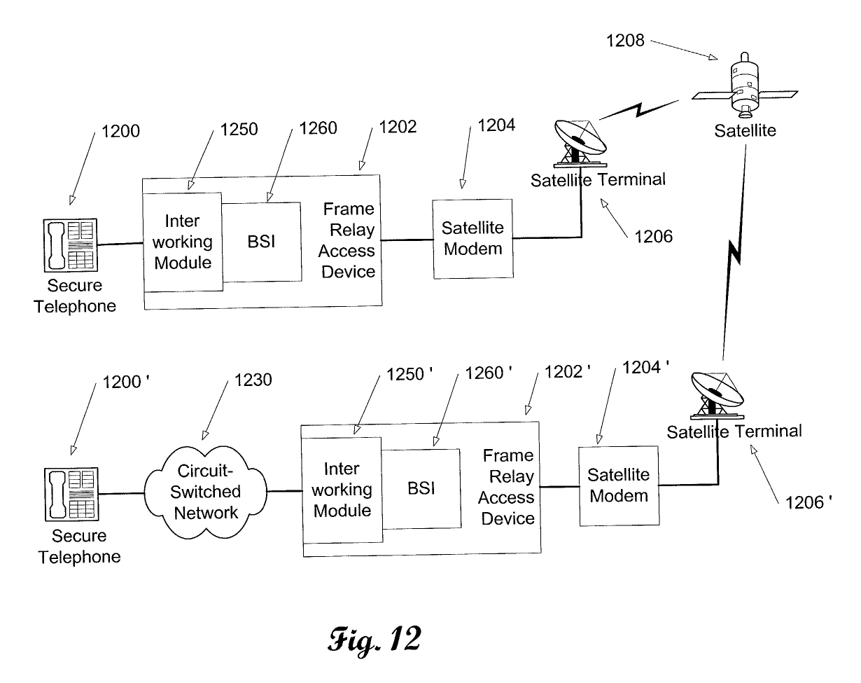

FIG. 12 depicts a system with a duplex connection identical to that in FIG. 11, except frame relay access devices 1202, 1202′ are used to aggregate and packetize traffic in the outbound path from secure telephone 1200 and in the inbound path to secure telephone 1200′, and in the return path from secure telephone 1200′ to secure telephone 1200.

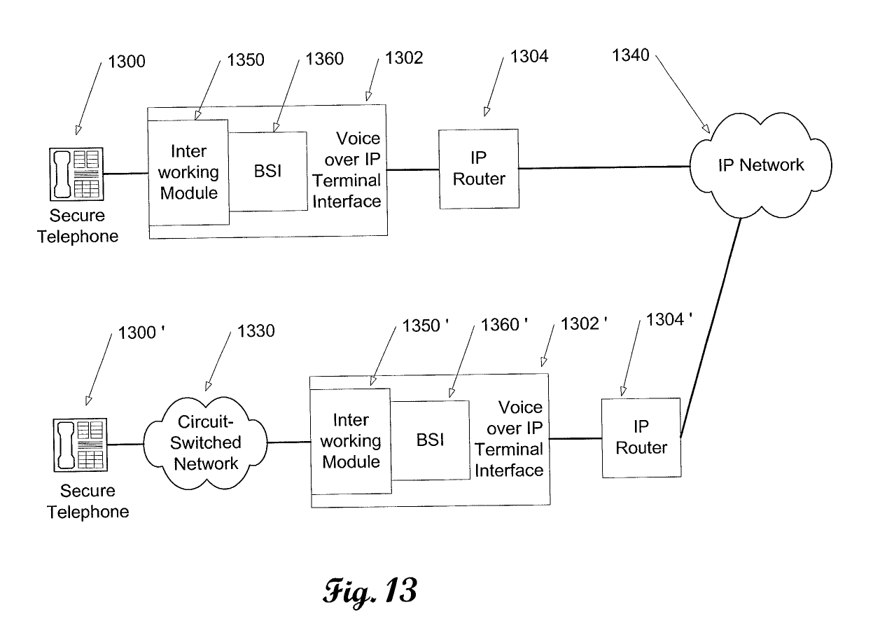

FIG. 13 depicts a system with a duplex connection using a BSI embodiment in which an interworking module 1150 and a BSI 1160 are integrated in a voice over Internet Protocol (“VOIP”) terminal interface 1302, which communicates through an Internet Protocol (“IP”) router 1304 over an IP network 1340. A IP router can combine traffic from multiple voice and data ports into a packetized, aggregate serial stream. IP router 1304 communicates with IP router 1304′, which provides a packet switched connection to VOIP terminal interface 1302′. Secure telephone 1300 is connected directly to VOIP terminal interface 1302, while secure telephone 1300′ is connected to VOIP interface 1302′ via a circuit-switched telephone network 1330. In this embodiment, the connection to a circuit-switched telephone network may be present on one side of a connection as illustrated, on both sides, or on neither side.

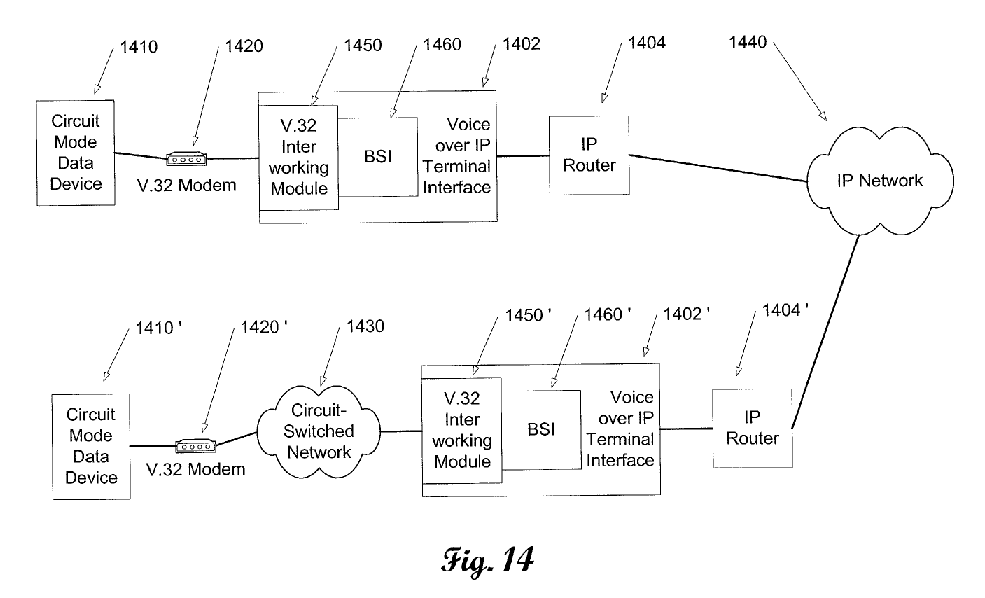

FIG. 14 depicts a system with a duplex connection identical to that in FIG. 13, except bit synchronous, circuit mode data device 1410 is used as a local terminal and bit synchronous, circuit mode data device 1410′ is used as a remote terminal. The circuit mode data devices are connected to a voice over Internet Protocol (“VOIP”) terminal interface 1402 via a standard V.32 modem 1420. The VOIP interface incorporates an interworking module 1450 which supports the V.32 training.

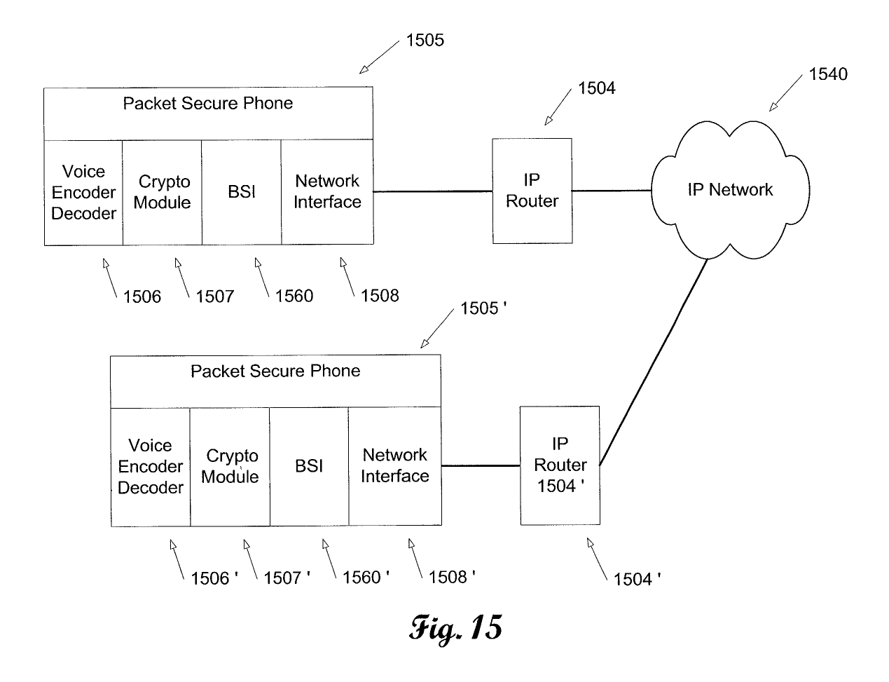

FIG. 15 depicts a system with a duplex connection in which BSI embodiments are integral components of packet mode secure phones 1505, 1505′. A packet mode secure phone interfaces with a packet-switched network, rather than with a circuit-switched network. A packet mode secure phone contains a voice encoder/decoder 1506, a cryptographic module 1507, a BSI 1550, and a packet network interface 1508. The packet mode secure phone communicates through an IP router 1504 over an IP network 1540. IP router 1504 communicates with IP router 1504′, which provides a packet switched connection to packet secure phone 1505′. Without a BSI, delayed, dropped, duplicated, and mis-sequenced packets would increase the frequency of failed calls using packet secure phones 1505, 1505′.

Those skilled in the art also will readily appreciate that many modifications to the invention are possible within the scope of the invention. Accordingly, the scope of the invention is not intended to be limited to the preferred embodiments described above, but only by the appended claims.

We claim:

1. A system for bit synchronous communications over a packet network using digital, circuit mode terminals, comprising:
a means associated with a local terminal for sequencing a bitstream generated by the local terminal into fixed-sized payloads with assigned sequence numbers,
a means associated with the local terminal for creating packets containing the payloads and assigned sequence numbers and transmitting the packets over the packet network,
a means associated with a remote terminal for receiving packets from the packet network and for extracting the payloads and assigned sequence numbers from the received packets,
a means associated with the remote terminal for ordering in a smoothing buffer the extracted payloads according to the sequence numbers assigned to each payload, and
a means associated with the remote terminal for sequentially outputting from the smoothing buffer for reception by the remote terminal a bitstream synchronized with a timing reference shared by the smoothing buffer and the remote terminal.

2. A system for bit synchronous communications over a packet network using analog, circuit mode terminals, comprising:
an interworking means associated with a local terminal for converting analog signal output from the local terminal into a bitstream,
a means associated with the local terminal for sequencing the bitstream generated by the interworking means into fixed-sized payloads with assigned sequence numbers,
a means associated with the local terminal for creating packets containing the payloads and assigned sequence numbers and transmitting the packets over the packet network,
a means associated with a remote terminal for receiving packets from the packet network and for extracting the packet payloads and assigned sequence numbers from the received packets,
a means associated with the remote terminal for ordering in a smoothing buffer the extracted payloads according to the assigned sequence number assigned to each payload,
a means associated with the remote terminal for sequentially outputting from the smoothing buffer a bitstream synchronized with a timing reference shared by the smoothing buffer and the remote terminal, and
an interworking means associated with the remote terminal for converting the bitstream read from the smoothing buffer into an analog signal for reception by the remote terminal.

3. A system for bit synchronous communications over a packet network using digital, circuit mode terminals, comprising:
a sequencer associated with a local terminal, wherein a bitstream generated by the local terminal is divided into fixed-sized payloads, buffered, a sequence number is assigned to each payload, and each pair of payload and assigned sequence number is output to a packetization, addressing, and transmission process that communicates with the packet network, and
a packet repair module associated with a remote terminal, wherein the packet repair module receives a bitstream of payloads and assigned sequence numbers extracted from packets addressed to the remote terminal and received from the packet network, orders in a smoothing buffer each received payload according to the sequence number assigned to each such payload, and sequentially outputs from the smoothing buffer for reception by the remote terminal a bitstream synchronized with a timing reference shared by the smoothing buffer and the remote terminal.

4. A system for bit synchronous communications over a packet network using analog, circuit mode terminals, comprising:
a sequencer associated with an interworking module interfaced with a local terminal, wherein a bitstream generated by the interworking module is divided into fixed-sized payloads, buffered, a sequence number is assigned to each payload, and each pair of payload and assigned sequence number is output to a packetization, addressing, and transmission process that communicates with the packet network, and
a packet repair module associated with an interworking module interfaced with a remote terminal, wherein the packet repair module receives a bitstream of payloads and assigned sequence numbers extracted from packets addressed to the remote terminal and received from the packet network, orders in a smoothing buffer each received payload according to the sequence number assigned to each such payload, and sequentially outputs from the smoothing buffer for reception by the associated interworking module a bitstream synchronized with a timing reference shared by the smoothing buffer and remote terminal.

5. The system of claim 1 or 2, wherein the specification of the payloads' fixed size implemented in a connection between the local and the remote terminal is by a control message generated by the sequencing means associated with the local terminal and transmitted to the ordering means associated with the remote terminal.

6. The system of claim 3 or 4, wherein the specification of the payloads' fixed size implemented in a connection between the local and the remote terminal is by a control message generated by the sequencer associated with the local terminal and transmitted to the packet repair module associated with the remote terminal.

7. The system of claim 1, 2, 3, or 4, wherein the determination of the payloads' fixed size implemented in a connection between the local and the remote terminal is based only on the datarate negotiated between the local terminal and the remote terminal.

8. The system of claim 1, 2, 3, or 4, wherein the timing reference shared by the smoothing buffer and the remote terminal is driven by a clock in the remote terminal.

9. The system of claim 1, 2, 3, or 4, wherein the timing reference shared by the smoothing buffer and the remote terminal is driven by the arrival time of the payloads extracted from received packets.

10. The system of claim 1, 2, 3, or 4, wherein the local terminal and the remote terminal are secure devices.

11. The system of claim 1, 2, 3, or 4, wherein the smoothing buffer associated with the remote terminal is a circular smoothing buffer.

12. The system of claim 1, 2, 3, or 4, wherein the smoothing buffer associated with the remote terminal is a linear smoothing buffer.

13. The system of claim 1, 2, 3, or 4, wherein a connection between the local terminal and the remote terminal is duplex.

14. The system of claim 1, 2, 3, or 4, wherein a connection between the local terminal and the remote terminal is simplex.

15. The system of claim 1, 2, 3, or 4, wherein in the absence of receipt of a payload for a given slot in the smoothing buffer, dummy data is written into such slot.

16. The system of claim 1 or 2, wherein the ordering means can perform a smoothing buffer adjustment and send a control message that initiates a resynchronization of the local and the remote terminals.

17. The system of claim 3 or 4, wherein the packet repair module can perform a smoothing buffer adjustment and send a control message that initiates a resynchronization of the local and the remote terminals.

18. The system of claim 1 or 2, wherein the ordering means can send a control message that changes the payloads' fixed size in a connection between the local terminal and the remote terminal, and conforms slots in the smoothing buffer to such fixed size.

19. The system of claim 3 or 4, wherein the packet repair module can send a control message that changes the payloads' fixed size in a connection between the local terminal and the remote terminal, and conforms slots in the smoothing buffer to such fixed size.

20. The system of claim 1 or 2, wherein the ordering means can receive a network management message, and in response to the network management message, send a control message that changes the payloads' fixed size in a connection between the local terminal and the remote terminal, and conforms slots in the smoothing buffer to such fixed size.

21. The system of claim 3 or 4, wherein the packet repair module can receive a network management message, and in response to the network management message, send a control message that changes the payloads' fixed size in a connection between the local terminal and the remote terminal, and conforms slots in the smoothing buffer to such fixed size.

22. The system of claim 1, 2, 3, or 4, in which the system for bit synchronous communications is used with a device selected from the group comprised of: statistical multiplexer, frame relay access device, voice over Internet Protocol terminal interface, Internet Protocol router, and packet mode secure phone.
